(19) United States
(12) Patent Application Publication
(10) Pub. No.: US 2026/0362401 A1
(43) Pub. Date: Nov. 12, 2026

(54) Method And Apparatus For Carrier Synchronization Of Response Frames In Wireless Communications

(71) Applicant: MediaTek Inc., Hsinchu City (TW)

(72) Inventors: Shuling Feng, San Jose, CA (US); Jianhan Liu, San Jose, CA (US); Hung-Tao Hsieh, Hsinchu City (TW); You-Wei Chen, San Jose, CA (US); Pochun Fang, Hsinchu City (TW)

(73) Assignee: MediaTek Inc., Hsinchu City (TW)

(21) Appl. No.: 19/670,026

(22) Filed: May 7, 2026

Related U.S. Application Data
(60) Provisional application No. 63/801,216, filed on May 7, 2025.

(51) Int. Cl. H04W 72/0446; H04W 24/10

(52) U.S. Cl. CPC H04W 72/0446; H04W 24/10

(57) ABSTRACT

Various schemes pertaining to carrier synchronization of response frames in wireless communications are described. An apparatus (e.g., a first access point (AP)) may receive a physical layer protocol data unit (PPDU) carrying a trigger frame transmitted by a second AP and a PPDU carrying a response frame transmitted by a station (STA) associated with the second AP. The apparatus may perform carrier frequency offset (CFO) compensation on the PPDU carrying the response frame to decode the response frame. The apparatus may obtain a CFO value used for the CFO compensation based on processing at least one of the PPDU carrying the trigger frame, preambles of the PPDU carrying the response frame, and a previously received PPDU carrying a trigger frame transmitted by the second AP.

### CROSS REFERENCE TO RELATED PATENT APPLICATION

The present disclosure is part of a non-provisional patent application claiming the priority benefit of U.S. Provisional Patent Application No. 63/801,216, filed 7 May 2025, the content of which being incorporated by reference in its entirety.

### TECHNICAL FIELD

The present disclosure is generally related to wireless communications and, more particularly, to method and apparatus for carrier synchronization of response frames in wireless communications.

### BACKGROUND

Unless otherwise indicated herein, approaches described in this section are not prior art to the claims listed below and are not admitted as prior art by inclusion in this section.

In a wireless communication system, communication devices may exchange control signals, data signals, or response signals to support subsequent transmission, reception, or other communication operations.

In some situations, a first communication device may receive a response signal triggered by a second communication device. For example, the first communication device may receive a response signal transmitted by another communication device associated with the second communication device. The response signal may carry measurement information, feedback information, control information, or other information.

In some designs, the response signal may be transmitted using a carrier frequency reference associated with the second communication device. Accordingly, the carrier frequency of the transmitted response signal may be aligned with the carrier frequency used by the second communication device rather than with the carrier frequency used by the first communication device.

Existing wireless communication standards may allow a receiver to process a subsequent response signal based on information included in a previously received signal. In some situations, such processing may reduce or avoid certain synchronization-related operations, thereby simplifying the reception of the response signal.

However, if the first communication device and the second communication device do not share the same carrier frequency reference, the first communication device may not correctly perform carrier synchronization when receiving the response signal. Such a condition may lead to decoding errors, information errors, or reception failure of the response signal.

Furthermore, in some multi-device coordination scenarios, differences in carrier frequency references among communication devices may become more significant. Accordingly, there is a need for improved reception mechanisms in wireless communications that can support carrier synchronization and decoding of response signals under different carrier frequencies among communication devices.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to carrier synchronization of response frames in wireless communications. Under various proposed schemes in accordance with the present disclosure, it is believed that the aforementioned issues may be addressed or otherwise alleviated.

In one aspect, a method may involve receiving, by a first access point (AP), a physical layer protocol data unit (PPDU) carrying a trigger frame transmitted by a second AP and a PPDU carrying a response frame transmitted by a station (STA) associated with the second AP. The method may also involve performing, by the first AP, carrier frequency offset (CFO) compensation on the PPDU carrying the response frame to decode the response frame. The first AP may obtain a CFO value used for the CFO compensation based on processing at least one of the PPDU carrying the trigger frame, preambles of the PPDU carrying the response frame, and a previously received PPDU carrying a trigger frame transmitted by the second AP.

In another aspect, a first AP may include a transceiver configured to communicate wirelessly and a processor coupled to the transceiver. The processor, during operation, may perform operations comprising receiving, via the transceiver, a physical layer protocol data unit (PPDU) carrying a trigger frame transmitted by a second AP and a PPDU carrying a response frame transmitted by a station (STA) associated with the second AP. The processor, during operation, may further perform operations comprising performing carrier frequency offset (CFO) compensation on the PPDU carrying the response frame to decode the response frame. The processor may obtain a CFO value used for the CFO compensation based on processing at least one of the PPDU carrying the trigger frame, preambles of the PPDU carrying the response frame, and a previously received PPDU carrying a trigger frame transmitted by the second AP.

It is noteworthy that, although description provided herein may be in the context of certain radio access technologies, networks and network topologies such as Wi-Fi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance an implementation of with the present disclosure.

FIG. 3 is a diagram of an example scenario in accordance with an implementation of the present disclosure.

FIG. 4 is a diagram of an example scenario in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to carrier synchronization of response frames in wireless communications. According to the present disclosure, a number of possible solutions may be implemented separately or jointly. That is, although these possible solutions may be described below separately, two or more of these possible solutions may be implemented in one combination or another.

In some scenarios, during a coordinated beamforming (Co-BF) joint sounding sequence or a cross-basic service set (BSS) sounding sequence of Co-BF sequential sounding, a Co-BF access point (AP) may need to overhear a cross-BSS channel state information (CSI) report or a joint CSI report triggered by another AP, such as an overlapping BSS (OBSS) AP. CSI report is a general name for beamforming feedback information. It could include compressed beamforming feedback and Channel Quality Indicator (CQI).

In some scenarios, the above description may also be applied to a Co-BF joint sounding sequence. In some implementations, during an example joint sounding sequence, an AP1 may transmit a null data packet announcement (NDPA) frame followed by a null data packet (NDP) for channel sounding, and a subsequent beamforming report poll (BFRP) trigger frame to trigger a CSI report from an associated station (STA 1). AP2 may transmit an NDP after receiving the NDPA frame. A short interframe space SIFS after receiving the BFRP, the STA 1 may then transmit a PPDU carrying a channel state information (CSI) report. In such scenarios, the PPDU carrying the CSI report may be transmitted with a carrier frequency synchronized to the carrier frequency of AP1, and the AP2 may overhear the PPDU carrying the CSI report and perform carrier synchronization operations as described below.

In some implementations, a station (STA) associated with the OBSS AP may pre-compensate a carrier frequency offset (CFO) and synchronize a carrier frequency of a trigger-based physical layer protocol data unit (TB PPDU) carrying a CSI report to the carrier frequency of the associated AP before transmitting the TB PPDU carrying the CSI report. Accordingly, when another AP overhears a TB PPDU carrying the CSI report, the carrier frequency of the CSI report may be aligned with the associated AP of the transmitting STA rather than with the overhearing AP.

In some scenarios, when a Co-BF AP overhears a beamforming report poll (BFRP) trigger frame transmitted by the OBSS AP, the Co-BF AP may configure a medium access control (MAC) entity to receive the CSI report as part of a trigger-based physical layer protocol data unit (TB PPDU) after a short interframe space (SIFS) time after the BFRP trigger frame.

Wi-Fi 6 and Wi-Fi 7 specifications for TB PPDUs may allow a receiver, such as an AP, to skip preamble processing of the TB PPDU and to use information included in a trigger frame to correctly decode the TB PPDU. However, in a Co-BF AP overhearing scenario involving a cross-BSS CSI report or a joint CSI report, the overhearing AP may not share the same carrier frequency reference as the AP associated with the transmitting STA. Therefore, the overhearing AP may not be able to skip all preamble-related processing when receiving the CSI report.

In some implementations, the overhearing AP may need to perform CFO correction on the CSI report even when the CSI report is received as part of a TB PPDU. For example, the overhearing AP may need to obtain a CFO compensation value and perform a CFO correction in order to correctly decode the CSI report. In some scenarios, the issue is not merely that different APs may operate with different carrier frequency references. Rather, the issue is how the overhearing AP can correctly obtain a CFO compensation value and perform CFO correction to ensure successful decoding of the CSI report.

In existing TB PPDU reception mechanisms, a receiver may decode a TB PPDU directly based on information contained in a trigger frame without re-processing a preamble. However, in Co-BF AP overhearing scenarios involving cross-BSS CSI reports or joint CSI reports, the carrier frequency of the CSI report may be aligned with the AP associated with the transmitting STA instead of with the overhearing AP. Accordingly, if the overhearing AP completely skips preamble processing according to existing TB PPDU reception rules, the overhearing AP may not be able to correctly perform carrier synchronization for the CSI report. Furthermore, if the CFO difference between two APs is relatively large, decoding of the CSI report may fail or may result in inaccurate CSI information.

In some scenarios, a Co-BF AP may overhear or receive a cross-BSS CSI report or a joint CSI report transmitted by a STA associated with another AP during a Co-BF joint sounding sequence or a cross-BSS sounding sequence. In some implementations, after overhearing or receiving a beamforming report poll (BFRP) trigger frame transmitted by an overlapping basic service set (OBSS) AP, the Co-BF AP may configure a medium access control (MAC) entity to receive the CSI report as part of either a trigger-based physical layer protocol data unit (TB PPDU) or a non-trigger-based physical layer protocol data unit (non-TB PPDU), a short interframe space (SIFS) time after the BFRP trigger frame. In some implementations, the Co-BF AP may perform CFO correction to correctly decode the CSI report.

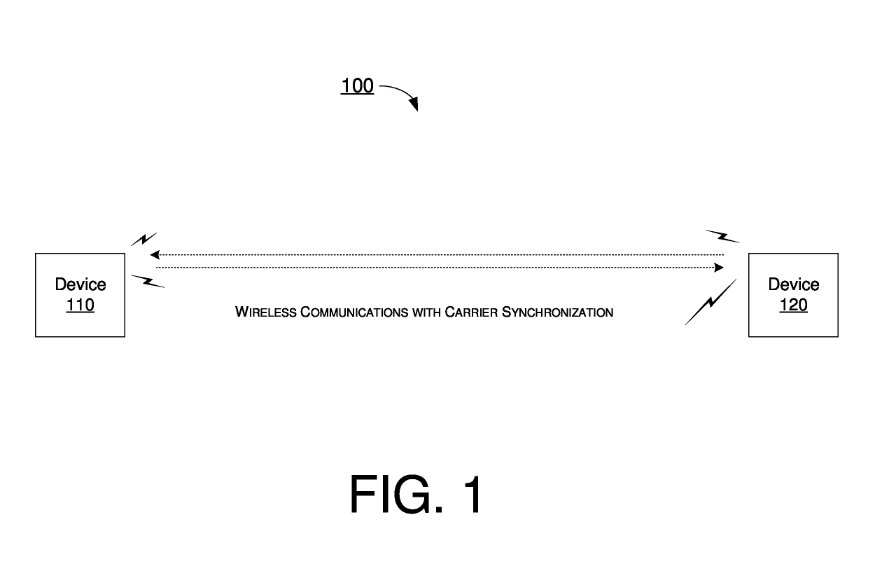

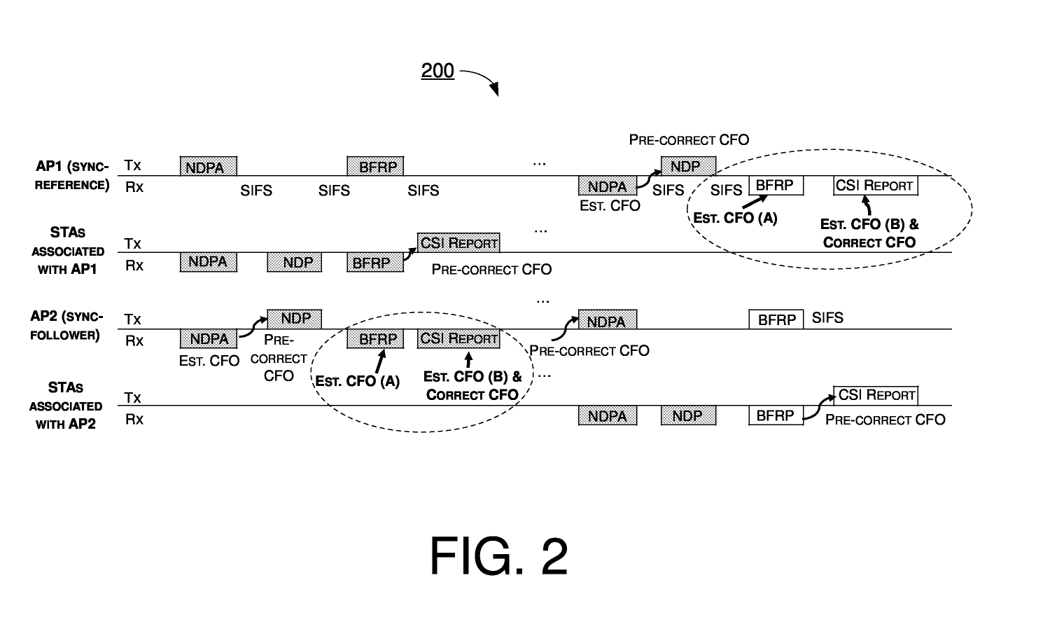

FIG. 1 illustrates an example network environment 100 in which various solutions and schemes in accordance with the present disclosure may be implemented. FIGS. 2 ~ 6 illustrate examples of implementation of various proposed schemes in network environment 100 in accordance with the present disclosure. The following description of various proposed schemes is provided with reference to FIGS. 1 ~ 6.

Referring to FIG. 1, network environment 100 may involve at least a device 110 and a device120 may be communicating wirelessly with each other in accordance with one or more IEEE 802.11 standards (e.g., IEEE 802.11be). Each of device 110 (herein interchangeably denoted as “device 1”) and device 120 (herein interchangeably denoted as “device 2”) may function as an AP or a non-AP STA. Moreover, each of device 110 and device 120 may perform carrier synchronization operations. Under various proposed schemes in accordance with the present disclosure, each of device 110 and device 120 may be configured to carry out synchronization operations for receiving a cross-BSS CSI report or a joint CSI report in wireless communications in accordance with various proposed schemes described below.

In some scenarios, a Co-BF AP may overhear or receive a CSI report transmitted by a STA associated with another AP during a Co-BF joint sounding sequence or a cross-BSS sounding sequence in Co-BF sequential sounding. In some implementations, different reception options may be used by the Co-BF AP to receive the cross-BSS CSI report or the joint CSI report. In some implementations, a coordinated beamforming (Co-BF) multi-AP coordination (MAPC) agreement is established between the Co-BF AP and the other AP.

In Option 1 and Option 2, the Co-BF AP may receive the cross-BSS CSI report or the joint CSI report as part of a trigger-based physical layer protocol data unit (TB PPDU). In some scenarios, the Co-BF AP may overhear or receive a beamforming report poll (BFRP) trigger frame transmitted by an OBSS AP. After receiving the BFRP trigger frame, the Co-BF AP may configure a medium access control (MAC) entity to receive the CSI report as part of a TB PPDU, a short interframe space (SIFS) time after the BFRP trigger frame. In some implementations, the Co-BF AP may perform CFO correction when receiving the TB PPDU in order to correctly decode the CSI report. The CFO value used for the CFO correction may be obtained in different ways. In Option 1, no CFO pre-correction may be applied to the BFRP trigger frame. In Option 2, a Co-BF sync-follower AP may apply CFO pre-correction on the BFRP trigger frame.

In Option 3, the Co-BF AP may receive a trigger-based physical layer protocol data unit (TB PPDU) carrying the cross-BSS CSI report or the joint CSI report. In some scenarios, the Co-BF AP may overhear or receive a BFRP trigger frame transmitted by the OBSS AP and may configure a MAC entity to receive the CSI report as part of a non-TB PPDU, a SIFS time after the BFRP trigger frame. That is, the PPDU carrying the cross-BSS CSI report or the joint CSI report is processed as a non-TB PPDU by the Co-BF AP.

In some implementations, when a PPDU carrying the CSI report is received, the Co-BF AP may process preambles of the PPDU for carrier synchronization and timing synchronization when receiving the PPDU. Although these options are illustrated in sequential sounding sequences, these options may also be applied to joint sounding sequences.

In some illustrations, color filled blocks may indicate a carrier frequency synchronized to AP1, which serves as a sync-reference AP, and non-color filled blocks may indicate a carrier frequency synchronized to AP2, which serves as a sync-follower AP.

FIG. 2 is a diagram of an example scenario 200 in accordance with the present disclosure. In some scenarios, FIG. 2 illustrates a Co-BF sequential sounding sequence in which a Co-BF AP receives a cross-BSS CSI report as part of a TB PPDU. FIG. 2 illustrates that, in some scenarios, a sync-reference AP may transmit a PPDU carrying a null data packet announcement (NDPA) frame, and a station (STA) associated with the sync-reference AP, as well as a sync-follower AP, may receive the PPDU carrying the NDPA frame. The sync-follower AP may transmit a PPDU carrying an NDP frame, and the STA associated with the sync-reference AP may receive the PPDU carrying the NDP frame. The sync-reference AP may then transmit a PPDU carrying a beamforming report poll (BFRP) trigger frame after a short interframe space (SIFS), and the associated STA may transmit a TB PPDU carrying a channel state information (CSI) report after another SIFS. FIG. 2 illustrates that, in some implementations, the sync-follower AP may estimate a carrier frequency offset (CFO) based on the received PPDU carrying the NDPA frame, the received PPDU carrying the BFRP trigger frame or the preambles of the TB PPDU, and may perform CFO correction when receiving the TB PPDU carrying the CSI report. In some scenarios, the STA may pre-correct the CFO of the STA based on the carrier frequency of the sync-reference AP before transmitting the TB PPDU carrying the CSI report, such that the TB PPDU carrying the CSI report is transmitted with a carrier frequency synchronized to the sync-reference AP. Accordingly, the sync-follower AP may perform CFO estimation and correction to correctly decode the CSI report.

In Option 1, during a cross-BSS sounding sequence or a joint sounding sequence, a Co-BF AP (e.g., the syn-follower AP in this embodiment) may overhear or receive a PPDU carrying a BFRP trigger frame transmitted by an OBSS AP (e.g., the syn-reference AP in this embodiment). In some implementations, after receiving the BFRP trigger frame, the Co-BF AP may configure a MAC entity to receive a CSI report as part of a TB PPDU, a SIFS time after the BFRP trigger frame.

In some implementations, the Co-BF AP may perform CFO correction when receiving the TB PPDU in order to correctly receive and decode the CSI report. In some scenarios, the STA transmitting the CSI report may pre-correct the CFO based on a carrier frequency reference of the associated AP. Therefore, the carrier frequency of the TB PPDU carrying the CSI report may be synchronized to the carrier frequency of the OBSS AP rather than to the carrier frequency of the Co-BF AP. In some implementations, the Co-BF AP may obtain a CFO value for the CFO correction in different ways.

In Method A, the Co-BF AP may estimate the CFO value when receiving the PPDU carrying the BFRP trigger frame transmitted by the OBSS AP. In Method B, the Co-BF AP may estimate the CFO value when receiving preambles of the TB PPDU carrying the CSI report. In Method C, the Co-BF AP may store a CFO value estimated when receiving a PPDU carrying a null data packet announcement (NDPA) frame transmitted by the OBSS AP. In some implementations, the stored CFO value may subsequently be used for CFO correction when the Co-BF AP receives the TB PPDU carrying the CSI report.

In some illustrations, AP1 may serve as a sync-reference AP, and AP2 may serve as a sync-follower AP. Color filled blocks may indicate transmissions synchronized to the carrier frequency of AP1, while non-color filled blocks may indicate transmissions synchronized to the carrier frequency of AP2.

In Option 1, a Co-BF AP may continue to receive a CSI report as part of a TB PPDU after overhearing or receiving a PPDU carrying a BFRP trigger frame transmitted by another AP. In some implementations, although the CSI report is received as part of a TB PPDU, the receiving AP may not completely skip preamble-related processing. Instead, the receiving AP may perform additional CFO correction in order to correctly decode the CSI report. In some scenarios, the receiving AP may obtain a CFO value in different ways. In Method A, the receiving AP may estimate the CFO value based on the PPDU carrying the BFRP trigger frame. In Method B, the receiving AP may estimate the CFO value based on a preamble of the PPDU carrying the CSI report. In Method C, the receiving AP may use a previously stored CFO value estimated when receiving a PPDU carrying a cross-BSS NDP or a PPDU carrying an NDPA frame. In some implementations, either AP1 or AP2 may serve as the overhearing AP. For example, when a transmitting STA transmitting the CSI report is associated with AP1, AP2 may perform CFO correction when receiving the CSI report. Similarly, when a transmitting STA transmitting the CSI report is associated with AP2, AP1 may perform CFO correction when receiving the CSI report. Accordingly, when an AP receives a CSI report transmitted by a STA not associated with the AP, the AP may compensate for a carrier frequency offset associated with the transmitting STA or the associated AP of the transmitting STA. In some implementations, Option 1 may maintain an existing TB PPDU reception procedure. In some implementations, no modification may be required at a transmitter side. In some implementations, Option 1 may be compatible with an existing trigger-based CSI report framework.

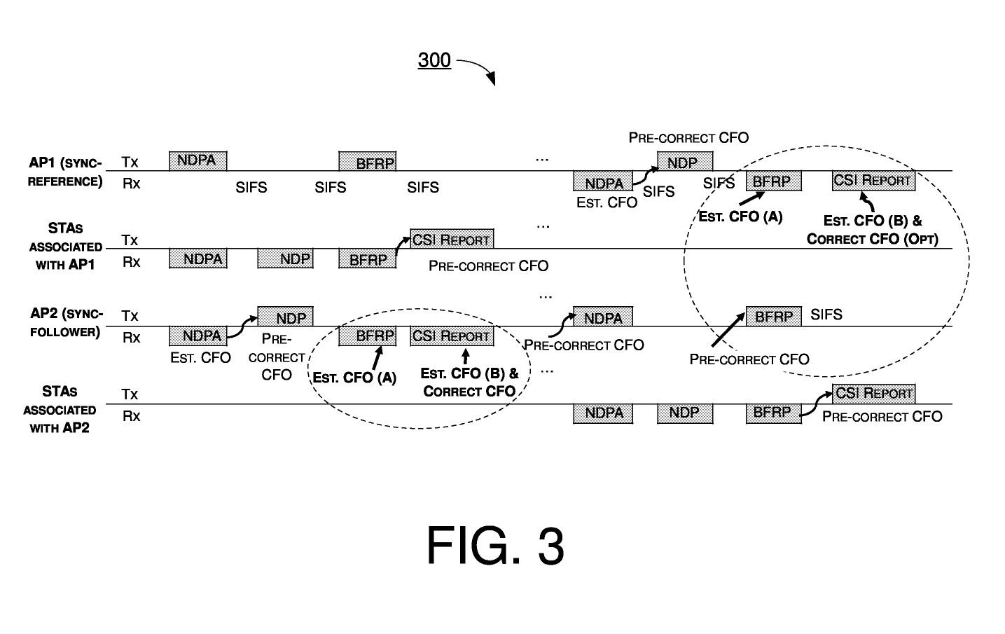

FIG. 3 is a diagram of an example scenario 300 in accordance with the present disclosure. In some scenarios, FIG. 3 illustrates a Co-BF sequential sounding sequence corresponding to Option 2, in which a Co-BF sync-follower AP applies CFO pre-correction on a BFRP trigger frame. In some implementations, when the sync-follower AP transmits a BFRP trigger frame to trigger a cross-BSS CSI report or a joint CSI report, the sync-follower AP may pre-correct CFO on the BFRP trigger frame based on a stored CFO value. In some implementations, after the BFRP trigger frame is transmitted, a STA associated with the sync-follower AP may transmit a CSI report as part of a TB PPDU. The TB PPDU carrying the CSI report may be transmitted with a carrier frequency synchronized to the sync-follower AP. In some scenarios, both the Co-BF sync-reference AP and the Co-BF sync-follower AP may perform CFO correction when receiving the TB PPDU carrying CSI report in a same manner as described for Option 1. In some implementations, the Co-BF sync-reference AP may optionally not perform CFO correction when receiving the TB PPDU carrying the CSI report. For example, when the TB PPDU carrying the CSI report is already frequency synchronized to the sync-reference AP, additional CFO correction may not be needed.

In Option 2, a sync-follower AP may perform CFO pre-correction on a BFRP trigger frame before transmitting the BFRP trigger frame. In some implementations, the sync-follower AP may use a previously stored CFO value to pre-correct the BFRP trigger frame. As a result, both the BFRP trigger frame and a subsequent CSI report may be frequency synchronized to a sync-reference AP. In some scenarios, the CFO value used for the pre-correction may be estimated based on an NDPA frame or an NDP transmitted by the sync-reference AP during a previous cross-BSS sounding sequence. In some implementations, the sync-follower AP may maintain a CFO memory storing a CFO relationship between the sync-follower AP and the sync-reference AP. The CFO memory may be updated over time based on subsequently received NDPA frames, NDPs, or other frames associated with the sync-reference AP. In some scenarios, when both the BFRP trigger frame and the CSI report are frequency synchronized to the sync-reference AP, a receiving AP may not need to perform additional CFO correction when receiving the CSI report. In some implementations, the receiving AP may still optionally perform CFO correction when receiving the CSI report in a same manner as described for Option 1. In some implementations, Option 2 may be regarded as a transmitter-side behavior because the sync-follower AP performs the CFO pre-correction before transmitting the BFRP trigger frame.

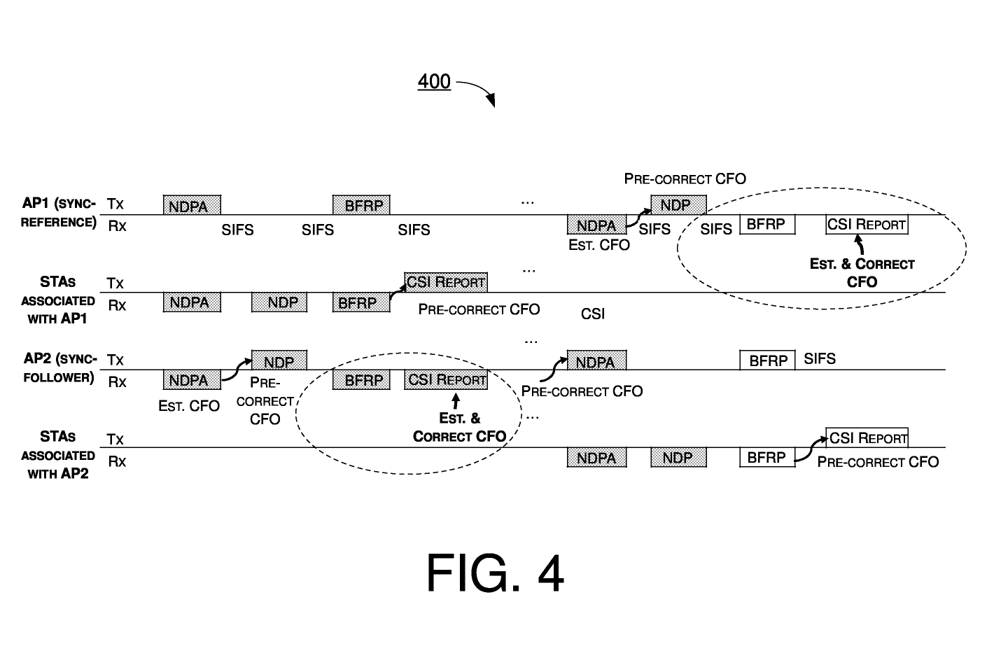

FIG. 4 is a diagram of an example scenario 400 in accordance with the present disclosure. In some scenarios, FIG. 4 illustrates a Co-BF sequential sounding sequence corresponding to Option 3, in which a Co-BF AP receives a cross-BSS CSI report in a TB PPDU. In some scenarios, during a cross-BSS sounding sequence or a joint sounding sequence, a Co-BF AP may overhear or receive a BFRP trigger frame transmitted by an OBSS AP. In some implementations, after receiving the BFRP trigger frame, the Co-BF AP may configure a MAC entity to receive a CSI report as part of a non-TB PPDU, a SIFS time after the BFRP trigger frame. In some implementations, the Co-BF AP may follow a conventional reception procedure for a non-TB PPDU when receiving the TB PPDU carrying the CSI report. In some implementations, the Co-BF AP may process preambles of the PPDU carrying the CSI report for carrier synchronization, timing synchronization, and symbol boundary detection. In some implementations, carrier synchronization may include CFO estimation and CFO correction. In some scenarios, because the PPDU carrying the CSI report may be transmitted with a carrier frequency synchronized to the carrier frequency of an AP associated with a transmitting STA, the receiving Co-BF AP may perform CFO estimation and CFO correction in order to correctly decode the CSI report in the PPDU.

In Option 3, after receiving a BFRP trigger frame transmitted by a cross-BSS AP, a Co-BF AP may not treat a subsequent PPDU carrying a CSI report as a TB PPDU. In some implementations, the Co-BF AP may instead treat the PPDU carrying the CSI report as a non-TB PPDU. In some implementations, when receiving the PPDU carrying the CSI report, the PPDU carrying the CSI report is processed as a non-TB PPDU. In some implementations, the preamble processing may include carrier synchronization, timing synchronization, symbol boundary detection, CFO estimation, and CFO correction. In some scenarios, Option 3 may differ from Option 1 in that, under Option 1, the PPDU carrying the CSI report may still be treated as a TB PPDU, and the Co-BF AP may additionally perform CFO correction, whereas under Option 3, the PPDU carrying the CSI report may be treated directly as a non-TB PPDU such that the Co-BF AP may perform a conventional preamble processing procedure for a non-TB PPDU procedure. In some implementations, Option 3 may not rely on an existing rule allowing a TB PPDU receiver to skip preamble processing. In some implementations, Option 3 may directly use a conventional synchronization procedure for a non-TB PPDU.

### Illustrative Implementations

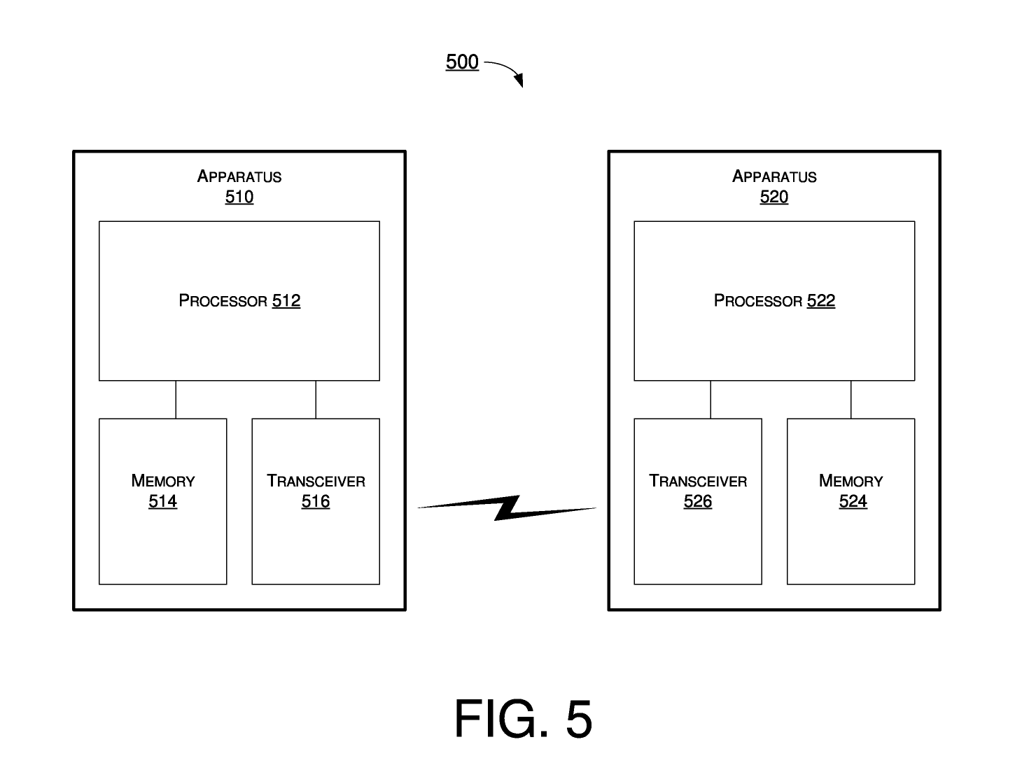

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to carrier synchronization of response frames in wireless communications, including the various schemes described above with respect to various proposed designs, concepts, schemes, systems and methods described above as well as processes described below. For instance, apparatus 510 may be implemented in device 110 and apparatus 520 may be implemented in device 120, or vice versa.

Each of apparatus 510 and apparatus 520 may be a part of an electronic apparatus, which may be a non-AP STA or an AP, such as a portable or mobile apparatus, a wearable apparatus, a wireless communication apparatus or a computing apparatus. When implemented in a non-AP STA, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in a network node, such as an AP in a WLAN.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 510 and apparatus 520 may be implemented in or as a non-AP STA or an AP. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to carrier synchronization of response frames in wireless communications in accordance with various implementations of the present disclosure.

In some implementations, apparatus 510 may also include a transceiver 516 coupled to processor 512. Transceiver 516 may include a transmitter capable of wirelessly transmitting and a receiver capable of wirelessly receiving data. In some implementations, apparatus 520 may also include a transceiver 526 coupled to processor 522. Transceiver 526 may include a transmitter capable of wirelessly transmitting and a receiver capable of wirelessly receiving data.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as device 110 (e.g., an AP or a first AP), and apparatus 520, as device 120 (e.g., a non-AP STA), is provided below. It is noteworthy that, although the example implementations described below are provided in the context of WLAN, the same may be implemented in other types of networks.

Under a proposed scheme pertaining to carrier synchronization of response frames in wireless communications in accordance with the present disclosure, with apparatus 510 implemented in or as device 110 (e.g., an AP or a first AP) and apparatus 520 implemented in or as device 120 in network environment 100 in accordance with one or more of IEEE 802.11 standards, processor 512 of apparatus 510 may receive, via transceiver 516, a physical layer protocol data unit (PPDU) carrying a trigger frame transmitted by apparatus 520 and a PPDU carrying a response frame transmitted by a station (STA) associated with apparatus 520. Processor 512 may perform CFO compensation on the PPDU carrying the response frame to decode the response frame. The processor 512 may obtain a CFO value used for the CFO compensation based on processing at least one of the PPDU carrying the trigger frame, preambles of the PPDU carrying the response frame, and a previously received PPDU carrying a trigger frame transmitted by apparatus 520.

In some implementations, the trigger frame may comprise a beamforming report poll (BFRP) trigger frame, and the response frame may comprise a frame containing beamforming feedback information.

In some implementations, the PPDU carrying the response frame may be a trigger-based physical layer protocol data unit (TB PPDU) carrying the response frame, and the processor 512 may obtain the CFO value used for the CFO compensation based on processing preambles of the TB PPDU carrying the response frame. In some implementations, the trigger frame may be a beamforming report poll (BFRP) trigger frame, and the response frame may be a frame containing beamforming feedback information. In some implementations, the PPDU carrying the response frame may be processed as a non-trigger-based physical layer protocol data unit (non-TB PPDU), and the processor may obtain the CFO value used for the CFO compensation based on processing preambles of the PPDU carrying the response frame. In some implementations, the processor 512 may estimate the CFO value based on the preambles of the TB PPDU carrying the response frame, and may perform the CFO compensation on data symbols of the TB PPDU carrying the response frame.

### Illustrative Processes

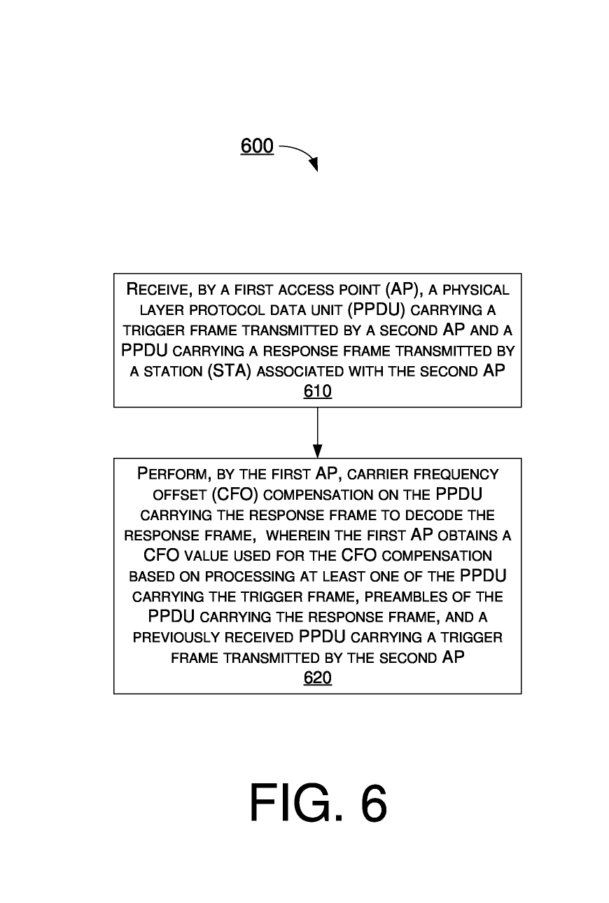

FIG. 6 illustrates an example process 600 in accordance with an implementation of the present disclosure. Process 600 may represent an aspect of implementing various proposed designs, concepts, schemes, systems and methods described above. More specifically, process 600 may represent an aspect of the proposed concepts and schemes pertaining to carrier synchronization of response frames in wireless communications in accordance with the present disclosure. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 implemented in or as device 110 (e.g., AP or first AP) and apparatus 520 implemented in or as device 120 (e.g., non-AP STA) of a wireless network such as a WLAN in network environment 100 in accordance with one or more of IEEE 802.11 standards. Process 600 may begin at block 610.

At 610, process 600 may involve processor 512 of apparatus 510 receiving, via transceiver 516, a physical layer protocol data unit (PPDU) carrying a trigger frame transmitted by apparatus 520 and a PPDU carrying a response frame transmitted by a station (STA) associated with apparatus 520. Process 600 may proceed from 610 to 620.

At 620, process 600 may involve processor 512 performing carrier frequency offset (CFO) compensation on the PPDU carrying the response frame to decode the response frame. Processor 512 may obtain a CFO value used for the CFO compensation based on processing at least one of the PPDU carrying the trigger frame, preambles of the PPDU carrying the response frame, and a previously received PPDU carrying a trigger frame transmitted by apparatus 520.

In some implementations, the trigger frame may comprise a beamforming report poll (BFRP) trigger frame, and the response frame may comprise a frame containing beamforming feedback information. In some implementations, the trigger frame may be transmitted by apparatus 520 having a coordinated beamforming (Co-BF) multi-AP coordination (MAPC) agreement with apparatus 510.

In some implementations, the response frame may be received in a cross-basic service set (BSS) coordinated beamforming (Co-BF) sounding sequence or a joint Co-BF sounding sequence. In some implementations, the processing of the preambles of the PPDU carrying the response frame may further comprise estimating, by processor 512, the CFO value based on the preambles of the PPDU carrying the response frame. In some implementations, the performing of CFO compensation on the PPDU carrying the response frame may comprise performing, by processor 512, the CFO compensation on data symbols of the PPDU carrying the response frame based on the CFO value. In some implementations, the first AP estimates the CFO value based on a first part of the preambles of the PPDU carrying the response frame and performs CFO compensation on a second part of the preambles and data symbols of the PPDU carrying the response frame. In some implementations, the first part of the preambles may comprise a Legacy Short Training Field (L-STF) and a Legacy Long Training Field (L-LTF), and the second part of the preambles may comprise one or more signal fields and at least one of a High Efficiency Long Training Field (HE-LTF), an Extremely High Throughput Long Training Field (EHT-LTF), or an Ultra High Reliability Long Training Field (UHR-LTF). In some implementations, the trigger frame carried in the previously received PPDU transmitted by apparatus 520 may comprise a null data packet announcement (NDPA) frame

In some implementations, the STA associated with apparatus 520 is not associated with apparatus 510, the PPDU carrying the response frame may be a trigger-based physical layer protocol data unit (TB PPDU) carrying the response frame, and the TB PPDU carrying the response frame may be transmitted with a carrier frequency synchronized to the carrier frequency of apparatus 520 that is different from a carrier frequency of apparatus 510.

In some implementations, process 600 may further involve processor 512 configuring a medium access control (MAC) entity to receive the response frame as part of the TB PPDU, a short interframe space (SIFS) after receiving the trigger frame. In some implementations, processor 512 may obtain a CFO value used for the CFO compensation based on processing the preambles of the TB PPDU carrying the response frame.

In some implementations, the processing of the preambles of the PPDU further may comprise estimating, by processor 512, the CFO value based on the preambles of the TB PPDU carrying the response frame. The performing of CFO compensation on the PPDU carrying the response frame may comprise performing, by processor 512, the CFO compensation on data symbols of the TB PPDU carrying the response frame.

In some implementations, the previously received frame transmitted by apparatus 520 may comprise a null data packet announcement (NDPA) frame.

In some implementations, the PPDU carrying the response frame may be a trigger-based physical layer protocol data unit (TB PPDU) carrying the response frame, and the TB PPDU carrying the response frame may be transmitted with a carrier frequency synchronized to apparatus 520 that may be different from a carrier frequency of apparatus 510. The PPDU carrying the response frame may be processed as a non-trigger-based physical layer protocol data unit (non-TB PPDU). In some implementations, process 600 may further involve processor 512 configuring a medium access control (MAC) entity to receive the response frame as a part of a non-trigger-based physical layer protocol data unit (non-TB PPDU) a short interframe space (SIFS) after receiving the trigger frame. In some implementations, the preamble processing may further comprise estimating, by processor 512, the CFO value based on preambles of the PPDU carrying the response frame, and the performing CFO compensation on the PPDU carrying the response frame may comprise performing, by processor 512, the CFO compensation on data symbols of the PPDU carrying the response frame

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected", or "operably coupled", to each other to achieve the desired functionality, and any two components capable of being so associated can also be viewed as being "operably couplable", to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to implementations

containing only one such recitation, even when the same claim includes the introductory phrases "one or more" or "at least one" and indefinite articles such as "a" or "an," e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of "two recitations," without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a first access point (AP), a physical layer protocol data unit (PPDU) carrying a trigger frame transmitted by a second AP and a PPDU carrying a response frame transmitted by a station (STA) associated with the second AP; and
performing, by the first AP, carrier frequency offset (CFO) compensation on the PPDU carrying the response frame to decode the response frame,
wherein the first AP obtains a CFO value used for the CFO compensation based on processing at least one of the PPDU carrying the trigger frame, preambles of the PPDU carrying the response frame, and a previously received PPDU carrying a trigger frame transmitted by the second AP.

2. The method of claim 1, wherein the trigger frame comprises a beamforming report poll (BFRP) trigger frame, and wherein the response frame comprises a frame containing beamforming feedback information.

3. The method of claim 1, wherein the trigger frame is transmitted by the second AP having a coordinated beamforming (Co-BF) multi-AP coordination (MAPC) agreement with the first AP.

4. The method of claim 1, wherein the response frame is received in a cross-basic service set (BSS) coordinated beamforming (Co-BF) sounding sequence or a joint Co-BF sounding sequence.

5. The method of claim 1, wherein the processing of the preambles of the PPDU carrying the response frame further comprises:
estimating, by the first AP, the CFO value based on the preambles of the PPDU carrying the response frame.

6. The method of claim 5, wherein the performing of CFO compensation on the PPDU carrying the response frame comprises:
performing, by the first AP, the CFO compensation on data symbols of the PPDU carrying the response frame based on the CFO value.

7. The method of claim 1, wherein the trigger frame carried in the previously received PPDU transmitted by the second AP comprises a null data packet announcement (NDPA) frame.

8. The method of claim 1, wherein the STA associated with the second AP is not associated with the first AP, wherein the PPDU carrying the response frame is a trigger-based physical layer protocol data unit (TB PPDU) carrying the response frame, and wherein the TB PPDU carrying the response frame is transmitted with a carrier frequency synchronized to the carrier frequency of the second AP that is different from a carrier frequency of the first AP.

9. The method of claim 8, further comprising:
configuring, by the first AP, a medium access control (MAC) entity to receive the response frame as part of the TB PPDU a short interframe space (SIFS) after receiving the trigger frame.

10. The method of claim 8, wherein the first AP obtains the CFO value used for the CFO compensation based on processing the preambles of the TB PPDU carrying the response frame.

11. The method of claim 10, wherein the processing of the preambles of the PPDU further comprises:
estimating, by the first AP, the CFO value based on the preambles of the TB PPDU carrying the response frame; and
wherein the performing of CFO compensation on the PPDU carrying the response frame comprises:
performing, by the first AP, the CFO compensation on data symbols of the TB PPDU carrying the response frame.

12. The method of claim 10, wherein the previously received frame transmitted by the second AP comprises a null data packet announcement (NDPA) frame.

13. The method of claim 1, wherein the PPDU carrying the response frame is a trigger-based physical layer protocol data unit (TB PPDU) carrying the response frame, and wherein the TB PPDU carrying the response frame is transmitted with a carrier frequency synchronized to the second AP that is different from a carrier frequency of the first AP, wherein the PPDU carrying the response frame is processed by the first AP as a non-trigger-based physical layer protocol data unit (non-TB PPDU).

14. The method of claim 13, further comprising:
configuring, by the first AP, a medium access control (MAC) entity to receive the response frame as a part of a non-TB PPDU a short interframe space (SIFS) after receiving the trigger frame.

15. The method of claim 13, wherein the preamble processing further comprises:
estimating, by the first AP, the CFO value based on the preambles of the PPDU carrying the response frame;
wherein the performing CFO compensation on the PPDU carrying the response frame comprises:
performing, by the first AP, the CFO compensation on data symbols of the PPDU carrying the response frame.

16. A first access point (AP), comprising:
a transceiver configured to communicate wirelessly; and
a processor coupled to the transceiver and configured to perform operations comprising:
receiving, via the transceiver, a physical layer protocol data unit (PPDU) carrying a trigger frame transmitted by a second AP and a PPDU carrying a response frame transmitted by a station (STA) associated with the second AP; and
performing carrier frequency offset (CFO) compensation on the PPDU carrying the response frame to decode the response frame,
wherein the processor obtains a CFO value used for the CFO compensation based on processing at least one of the PPDU carrying the trigger frame, preambles of the PPDU carrying the response frame, and a previously received PPDU carrying a trigger frame transmitted by the second AP.

17. The first AP of claim 16, wherein the trigger frame comprises a beamforming report poll (BFRP) trigger frame, and wherein the response frame comprises a frame containing beamforming feedback information.

18. The first AP of claim 16, wherein the PPDU carrying the response frame is a trigger-based physical layer protocol data unit (TB PPDU) carrying the response frame, and the processor obtains the CFO value used for the CFO compensation based on processing preambles of the TB PPDU carrying the response frame.

19. The first AP of claim 16, wherein the PPDU carrying the response frame is processed as a non-trigger-based physical layer protocol data unit (non-TB PPDU), and the processor obtains the CFO value used for the CFO compensation based on processing preambles of the PPDU carrying the response frame.

20. The first AP of claim 18, wherein the processor estimates the CFO value based on the preambles of the TB PPDU carrying the response frame, and performs the CFO compensation on data symbols of the TB PPDU carrying the response frame.
